(19) United States
(12) Patent Application Publication
(10) Pub. No.: US 2021/0021976 A1
(43) Pub. Date: Jan. 21, 2021

(54) IN-VEHICLE DEVICE AND DATA COMMUNICATION METHOD THEREOF

(71) Applicants: Hyundai Motor Company, Seoul (KR); Kia Motors Corporation, Seoul (KR)

(72) Inventor: Joon Young KIM, Seongnam-si (KR)

(73) Assignees: HYUNDAI MOTOR COMPANY, Seoul (KR); KIA MOTORS CORPORATION, Seoul (KR)

(21) Appl. No.: 16/587,998

(22) Filed: Sep. 30, 2019

(30) Foreign Application Priority Data
Jul. 16, 2019 (KR) 10-2019-0085717

(51) Int. Cl. H04W 4/48; H04W 24/08; H04W 76/10; H04W 4/38

(52) U.S. Cl. CPC H04W 4/48; H04W 24/08; H04W 80/02; H04W 4/38; H04W 76/10

(57) ABSTRACT

An in-vehicle device and a data communication method thereof are provided. The in-vehicle device may include a transceiver configured to transmit or receive a packet and a processor configured to control an operation of the transceiver. The processor may be configured to collect an amount of data transfer of a plurality of in-vehicle devices within a vehicle wireless network, establish a data link depending on a link type within the wireless network based on the amount of data transfer of the plurality of in-vehicle devices, determine a wireless communication and a data format based on an in-vehicle device situation and a link situation through the established data link, and transmit or receive a data packet depending on the determined wireless communication and the determined data format.

### CROSS-REFERENCE TO RELATED APPLICATION

The present application claims priority to and the benefit of Korean Patent Application No. 10-2019-0085717, filed on Jul. 16, 2019, which is incorporated herein by reference in its entirety.

### TECHNICAL FIELD

The present disclosure relates to an in-vehicle device and a data communication method thereof.

### BACKGROUND

The statements in this section merely provide background information related to the present disclosure and may not constitute prior art.

A vehicle communication network may be divided into an in-Vehicle Network (IVN) and an external network of a vehicle. For example, because the IVN, for example, Controller Area Network (CAN), Ethernet, and the like is implemented with a wire, the network failure may occur due to cable problems. To solve the above-described issue, an Internet of Things (IoT)-based sensor, an IoT-based device, and the like may be applied to the vehicle.

However, because the wireless communication and the protocol associated with IoT are present variously, the wireless communication and the protocol applied to each IoT device may be different. Accordingly, because the wireless communication and the protocol are different for each IoT device when each IoT device statically sets the wireless communication and the protocol, the communication may be impossible.

### SUMMARY

The present disclosure provides an in-vehicle device that determines the wireless communication and the protocol for transmitting or receiving data in consideration of the situations of a device and a link within a vehicle wireless network, and a data communication method thereof.

The technical problems to be solved by the present inventive concept are not limited to the aforementioned problems, and any other technical problems not mentioned herein will be clearly understood from the following description by those skilled in the art to which the present disclosure pertains.

In one form of the present disclosure, an in-vehicle device includes a transceiver transmitting or receiving a packet and a processor controlling an operation of the transceiver. The processor collects an amount of data transfer of in-vehicle devices within a vehicle wireless network, establishes a data link depending on a link type within the wireless network based on the amount of data transfer of the in-vehicle devices, determines wireless communication and a data format by grasping an in-vehicle device situation and a link situation through the established data link, and transmits or receives a data packet depending on the determined wireless communication and the determined data format.

The processor establishes a first protocol-based data link or a second protocol-based data link depending on possibility of a change of a first link connecting the in-vehicle device to another in-vehicle device when the wireless network is composed of a single link.

The processor grasps data transfer performance of a second link connected to the another in-vehicle device, compares the data transfer performance of the second link with data transfer performance of the first link, analyzes the compared result, and establishes a first protocol-based data link or a second protocol-based data link depending on the analysis result, when the wireless network is composed of multiple links.

The processor collects situation information of the in-vehicle device and a link through the established data link and determines the data format level in consideration of the collected situation information.

The processor determines the data format level in consideration of at least one of whether there is a need to maintain a link connection, whether wireless band interference persists, possibility of movement of a device, and a transfer packet size.

The processor determines the wireless communication in consideration of at least one of whether there is a need to maintain a link connection, whether wireless band interference persists, possibility of movement of a device, a transfer packet size, whether the packet is high-capacity data, and streaming transmission.

The data format includes a field for header information, a field for a transaction ID, a field for protocol setting, which is negotiated between devices, and a flag, a field into which data is inserted, and a field for an error check code.

The data format further includes a field into which whether to maintain a link connection is inserted, and a field for whether there is a need for multicast.

The data format further includes a field in which a wireless communication standard is included, and a field in which reception signal strength is stored.

The data format further includes a field, in which whether a device is moved is stored, and a field in which a time required to maintain the data format is stored.

In another form of the present disclosure, a data communication method includes collecting an amount of data transfer of in-vehicle devices within a vehicle wireless network, establishing a data link based on the amount of data transfer of the in-vehicle devices depending on a link type within the wireless network, determining wireless communication and a data format by grasping an in-vehicle device situation and a link situation through the data link, and transmitting and receiving a data packet depending on the wireless communication and the data format.

The establishing of the data link includes establishing a first protocol-based data link or a second protocol-based data link depending on whether a first link between an in-vehicle device and another in-vehicle device is capable of being changed, when the link type corresponds to a single link.

The establishing of the data link includes collecting information of a second link of the another in-vehicle device when the link type corresponds to multiple links, determining whether data transfer performance of the second link exceeds data transfer performance of the first link, based on information of the second link, determining whether it is possible to proceed with negotiation between the in-vehicle device and the another in-vehicle device, when the data transfer performance of the second link exceeds the data transfer performance of the first link, and establishing the first protocol-based data link or the second protocol-based data link depending on possibility of changes of the first link and the second link, when it is possible to proceed with the negotiation between the in-vehicle device and the another in-vehicle device.

The determining of the wireless communication and the data format includes identifying the wireless communication and the protocol, which are capable of being used in common between the in-vehicle device and the another in-vehicle device, to perform handshaking, collecting information about the in-vehicle device situation and the link situation, using the wireless communication and the protocol, which are capable of being used in common, to determine a wireless communication standard and a data format level in consideration of the collected information, determining whether communication is possible, through transmission and reception of a test packet at the wireless communication standard and the data format level, and finally determining the wireless communication standard and the data format level as the wireless communication and the data format depending on whether the communication is possible.

The determining of the wireless communication standard and the data format level includes determining the data format level in consideration of at least one of whether there is a need to maintain a link connection, whether wireless band interference persists, possibility of movement of a device, and a transfer packet size.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exemplary view illustrating an example of a configuration of a wireless network in a vehicle in one form of the present disclosure;

FIG. 2 illustrates a block diagram of an in-vehicle device in one form of the present disclosure;

FIG. 3A is a view illustrating data format in a first protocol in one form of the present disclosure;

FIG. 3B is a view illustrating data format in a second protocol in one form of the present disclosure;

FIG. 4 is a flowchart illustrating a data communication method of an in-vehicle device in one form of the present disclosure;

FIG. 5 is a flowchart illustrating a procedure of establishing data link illustrated in FIG. 4;

FIG. 6 is a flowchart illustrating a procedure of determining wireless communication and a final data format illustrated in FIG. 4; and

FIG. 7 is a flowchart illustrating a procedure of determining wireless communication and a data format level illustrated in FIG. 6.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some forms of the present disclosure will be described in detail with reference to the exemplary drawings. In adding the reference numerals to the components of each drawing, it should be noted that the identical or equivalent component is designated by the identical numeral even when they are displayed on other drawings. Further, in describing some forms of the present disclosure, a detailed description of well-known features or functions will be ruled out in order not to unnecessarily obscure the gist of the present disclosure.

In describing some form of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

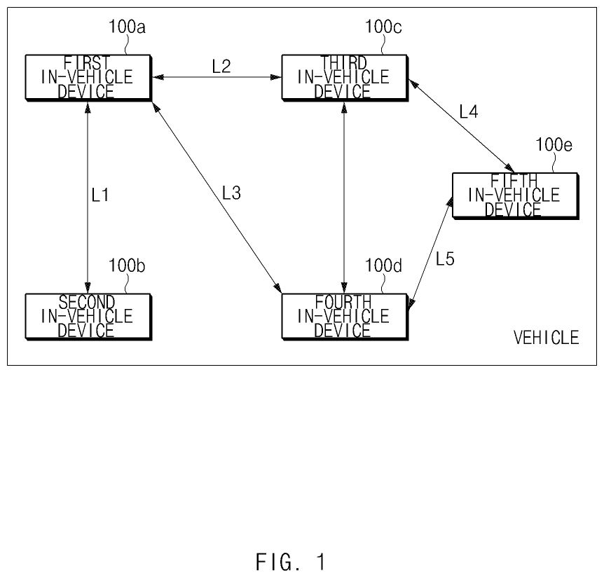

FIG. 1 is an exemplary view illustrating an example of a configuration of a wireless network in a vehicle in some forms of the present disclosure.

The wireless network (wireless communication network) in a vehicle may be formed by at least two or more in-vehicle devices mounted in the vehicle. Each of the two or more in-vehicle devices may utilize at least one wireless communication technology. Wireless LAN (Wi-Fi), Wi-Fi direct, ZigBee, Z-wave, Bluetooth (BT), Radio Frequency (RF), IPv6 over low power wireless Personal Area Networks (6LowPAN), General Packet Radio Service (GPRS), 3Generation (3G), Long Term Evolution (LTE), LTE Direct, Near Field Communication (NFC), Constrained Application Protocol (CoAP), and/or Message Queueing Telemetry Transport (MQTT) may be used as the wireless communication technology.

As illustrated in FIG. 1, first to fifth in-vehicle devices 100a to 100e may form one wireless network in a vehicle. The first in-vehicle device 100a is connected to the second in-vehicle device 100b via a first link L1, is connected to the third in-vehicle device 100c via a second link L2, and is connected to the fourth in-vehicle device 100d via a third link L3. The third in-vehicle device 100c is connected to the fifth in-vehicle device 100e via a fourth link L4; the fifth in-vehicle device 100e is connected to the fourth in-vehicle device 100d via a fifth link L5. Each in-vehicle device 10a, 100b, 100c, 100d, or 100e may be a sensing device, an actuator (e.g., a motor, a switch, a speaker and/or a lamp), Electric Control Units (ECUs) or the like, as an IoT device capable of data communication and data processing.

Some forms of the present disclosure disclose, but not limited to, the wireless network in a vehicle formed by the five in-vehicle devices 100a to 100e. However, the network configuration is possible in various forms.

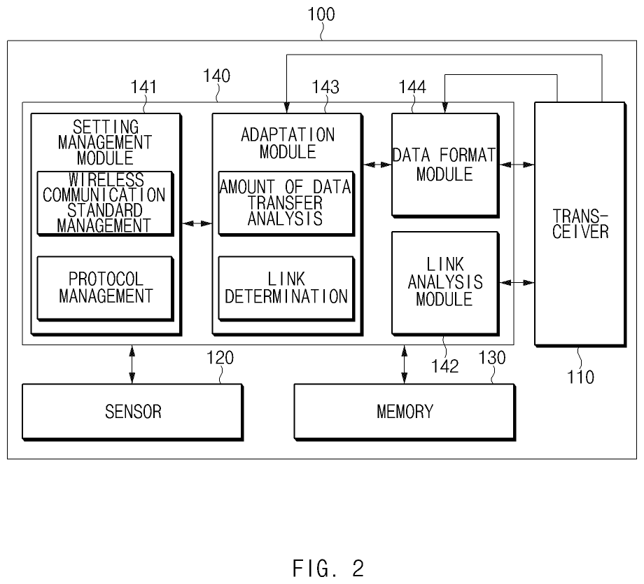

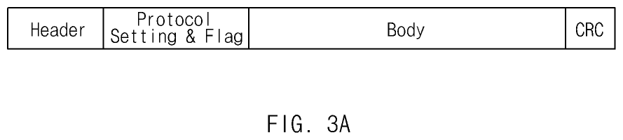

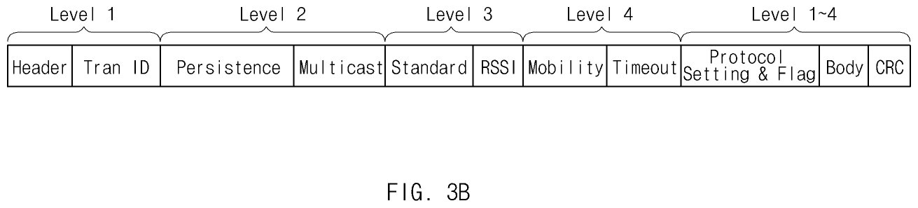

FIG. 2 illustrates a block diagram of an in-vehicle device, in some forms of the present disclosure. FIG. 3A is a view illustrating data format in a first protocol associated with the present disclosure. FIG. 3B is a view illustrating data format in a second protocol in some forms of the present disclosure.

Referring to FIG. 2, an in-vehicle device 100 includes a transceiver 110, a sensor 120, a memory 130, and a processor 140.

The transceiver 110 transmits or receives data (packet), using at least one wireless communication technology (i.e., communication scheme). In other words, the transceiver 110 performs packet transmission or reception depending on at least one wireless communication standard. The transceiver 110 includes a transmitter transmitting data from the inside to the outside of the in-vehicle device 100 and a receiver receiving data flowing in from the outside to the inside of the in-vehicle device 100. The transceiver 110 may measure data traffic (i.e., the amount of data transfer) of at least one link (i.e., communication channel) connected to the in-vehicle device 100.

The sensor 120 obtains information of the surrounding environment of the in-vehicle device 100, that is, the environment in a vehicle, a condition of the vehicle, or the like. The sensor 120 may include a temperature sensor, a humidity sensor, an ultrasonic sensor, a pressure sensor, an acceleration sensor, an illuminance sensor, a wheel sensor, and/or a virtual sensor. The virtual sensor generates new sensing data, using the sensing data measured by a physical sensor such as the temperature sensor, the humidity sensor, and/or the ultrasonic sensor.

The memory 130 may store software programmed such that the processor 140 performs a specified operation. The memory 130 may store a wireless communication determination algorithm, a protocol determination algorithm, and the like. The memory 130 may store the wireless communication standard applied to the in-vehicle device 100, whether the wireless communication standard is available, a protocol list applied to the in-vehicle device 100, whether the protocol list is available, and the like. The memory 130 may be implemented with at least one or more storage media (recording media) among a flash memory, a hard disk, a Secure Digital (SD) card, a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), a register, a removable disc, and the like.

The processor 140 determines (selects) a wireless communication standard (hereinafter referred to as “wireless communication”) and/or a protocol in consideration of the situation (environment or condition) information of the device and the link within a vehicle wireless network and performs data transmission or reception depending on the determined wireless communication standard and the determined protocol. Herein, the situation information (hereinafter referred to as a “device information”) of a device may be information about each of the in-vehicle devices 100 connected to a wireless network and may include at least one of pieces of information of the mobility of the device, the amount of data transfer, an available wireless communication standard (physical layer), the number of links connected to the device, whether there is a need for multicast, and the like. The situation information (link information) of the link may be condition information about the link that is a communication channel and may include at least one of pieces of information of Received Signal Strength Indicator (RSSI), Radio interference, a link rate, a link connection relationship, and whether the connection persists.

The processor 140 includes a setting management module 141, a link analysis module 142, an adaptation module 143, and a data format module 144.

The setting management module 141 manages at least one wireless communication and at least one protocol, which are applied to the in-vehicle device 100. The setting management module 141 manages a wireless communication standard, in which the rule associated with a wireless communication technology, that is, a communication scheme is defined, whether each wireless communication standard is available, and the like. Furthermore, the setting management module 141 manages a protocol list applied to the in-vehicle device 100 and whether each protocol is available. Herein, the protocol means a data link layer protocol and is classified into a primary protocol (hereinafter referred to as a “first protocol”) and a non-primary protocol (hereinafter referred to as a “second protocol”). The protocol may include a data format, encoding, a signal level, and the like.

The data format in the first protocol may be used upon performing handshaking between in-vehicle devices in the wireless network. Referring to FIG. 3A, the data format in the first protocol includes a header field, a protocol setting and flag field, a body field, and a cyclical redundancy check (CRC) field. A transaction identification (ID) and transceiver identifiers are stored (inserted) in the header field. The information of a protocol negotiated between the transceiver 110 of the in-vehicle device 100 and the transceiver of another in-vehicle device 100, a selection flag, and the like are stored in the protocol setting and flag field. Before the setting of the protocol between the in-vehicle device 100 and the other in-vehicle device is consented, at least one of protocols capable of being used to transmit or receive data between the in-vehicle device 100 and the other in-vehicle device is stored in the protocol setting and flag field. The data (payload) and a condition code are included in the body field; the length of the body field may be changed depending on a channel condition, that is, a link condition and/or the mobility situation of a device. The CRC field includes an error detection code for error verification of data.

The data format in the second protocol is used after the handshaking between in-vehicle devices in the wireless network, and it is possible to set the level of the data format. Referring to FIG. 3B, the data format of the second protocol is composed of a header field, a transaction ID (Tran ID) field, a persistence field, a multicast field, a standard field, an RSSI field, a mobility field, a timeout field, a protocol setting and flag field, a body field, and a CRC field. The header field may include information of a data length, a priority, a destination address, or the like. The persistence field includes whether a link connection persists; the multicast field includes whether there is a need for multicast; the standard field includes a wireless communication standard of a physical layer. The RSSI field includes the received signal strength (intensity); the mobility field includes whether a device is moved; the timeout field includes the data format hold time. The processor 140 may set a timer (not illustrated) based on the data format hold time. The timer (not illustrated) may generate an event when the data format hold time elapses.

The data format based on the second protocol may be changed depending on level settings. In more detail, a level 1 data format is used independently of the surrounding situation (the environment in a vehicle) of a device and a link condition and is composed of a header field, a transaction ID field, a protocol setting and flag field, a body field, and a CRC field. Because there is a need to determine whether a link connection is maintained and whether multicast is present when the number of links connected to the device is two or more multi links, a level 2 data format is used in this case. That is, the level 2 data format is formed by adding the persistence field and the multicast field to the level 1 data format. A level 3 data format is used when there is an influence by the wireless environment around the device and is formed by adding the standard field and the RSSI field to the level 2 data format. A level 4 data format is used when there is a need to determine the power consumption of the device according to the mobility of the device and the transfer packet size (data size). The level 4 data format may be formed by adding the mobility field and the timeout field to the level 3 data format.

The link analysis module 142 analyzes the condition (situation) of at least one link within a wireless network. The link analysis module 142 may analyze the link rate (transmission rate), RSSI, a link connection relationship, connection persistence, and the like for transmitting the packet of a link.

The adaptation module 143 may measure and obtain the amount of data transfer of each of the in-vehicle device 100 and at least another in-vehicle device within the wireless network. For example, the adaptation module 143 of the first in-vehicle device 100a may directly measure the amount of data transfer of each of the second in-vehicle device 100b, the third in-vehicle device 100c, and the fourth in-vehicle device 100d through the transceiver 110. Moreover, the adaptation module 143 of the first in-vehicle device 100a may communicate with the third in-vehicle device 100c or the fourth in-vehicle device 100d through the transceiver 110 to obtain the amount of data transfer of the fifth in-vehicle device 100e. The adaptation module 143 may grasp the data traffic condition of devices (i.e., the in-vehicle device 100 and at least another in-vehicle device) within the wireless network. The adaptation module 143 transmits the data traffic and wireless network analysis result, the link determination and link analysis result, or the like to the setting management module 141.

The adaptation module 143 may determine a link in consideration of the number of links connected to the in-vehicle device 100, link information, and the like. The adaptation module 143 determines whether the corresponding link is capable of being changed, when the link within the wireless network is a single link. In other words, the adaptation module 143 determines whether the link depends on the surrounding environment of the device and a link condition. The adaptation module 143 determines that the link is capable of being changed, when the link depends on the surrounding environment of the device and the link condition; the adaptation module 143 determines that the link is not capable of being changed, when the link does not depend on the surrounding environment of the device and the link condition. The adaptation module 143 selects the first protocol-based link when the link is not capable of being changed; the adaptation module 143 selects the second protocol-based link when the link is capable of being changed.

In the meantime, the adaptation module 143 collects the condition information of other links of other in-vehicle devices connected to multiple links, compares the condition information of the other links with the condition information of the link connected to the in-vehicle device 100, and analyzes the comparison result, when the link within the wireless network corresponds to multiple links. For example, in FIG. 1, the second in-vehicle device 100b needs to consider the situation (condition) of each of the link L2 between the first in-vehicle device 110a and the third in-vehicle device 100c and the link L3 between the first in-vehicle device 110a and the fourth in-vehicle device 100d, in addition to the link L1 between the first in-vehicle device 100a and the second in-vehicle device 100b. The adaptation module 143 determines whether the negotiation of the bandwidth and data rate of the link between the in-vehicle device 100 and other in-vehicle devices is possible, in the case where the bandwidth and/or data rate of the other links exceeds an available bandwidth and/or data rate when the link connected to the in-vehicle device 100 is single. The adaptation module 143 determines whether the multiple links and other links are capable of being changed, when the negotiation of the bandwidth and data rate between the in-vehicle device 100 and the other in-vehicle devices is possible. The adaptation module 143 determines the first protocol-based link when the multiple links and other links are not capable of being changed; the adaptation module 143 determines the second protocol-based link when the multiple links and other links are capable of being changed. Furthermore, the adaptation module 143 selects the first protocol-based link when the bandwidth and/or data rate of other links does not exceed the available bandwidth and/or data rate in the case where the link connected to the in-vehicle device 100 is single or when the negotiation of the bandwidth and data rate between the in-vehicle device 100 and in-vehicle devices is impossible. The adaptation module 143 establishes the selected first protocol-based link or the selected second protocol-based link. The adaptation module 143 may perform initial handshaking through the collected link.

The data format module 144 builds the data format according to the protocol selected by the adaptation module 143. The data format module 144 finally selects the data format through the handshaking.

The data format module 144 may identify the wireless communication and protocol, which are capable of transmission and reception between the in-vehicle device 100 and another in-vehicle device, through the link established by the adaptation module 143. The data format module 144 identifies the situation for each device, the situation for each link, and the like through the initial handshaking and sets (determines) the final data format based on the identified result. The data format module 144 sets wireless communication in consideration of whether there is a need to maintain a link connection and whether wireless band interference persists and sets the protocol, that is, the final data format in consideration of whether there is a need to maintain a link connection, the mobility (possibility of movement) of a device, a transfer packet size, and the like.

The data format module 144 determines that the wireless communication and data format are interference avoidance wireless communication and the level 1 data format, when there is no need to maintain the link connection but the wireless band interference persists. In the meantime, the data format module 144 determines that the wireless communication and data format are low-power wireless communication and the level 1 data format, when there is no need to maintain the link connection and the wireless band interference does not persist. The data format module 144 determines that the wireless communication and data format are low-power wireless communication and the level 2 data format, when there is a need to maintain the link connection and the wireless band interference does not persist. In the meantime, the data format module 144 determines that the wireless communication and data format are interference avoidance and high-power wireless communication and the level 3 data format, when there is a need to maintain the link connection, when the wireless band interference persists, and when the movement of the device is impossible. The data format module 144 may select high-capacity wireless communication when there is a need for high-capacity data and/or streaming transmission after the data format module 144 determines the level 1 data format, the level 2 data format, or the level 3 data format; the data format module 144 may select low-capacity wireless communication when there is no need for high-capacity data and/or streaming transmission. The data format module 144 determines that the wireless communication and data format are the high-capacity wireless communication and the level 4 data format and revises timeout settings when there is a need to maintain a link connection, when the wireless band interference persists, when the movement of the device is possible, and when the transfer packet size is not less than a reference size. In the meantime, the data format module 144 determines that the wireless communication and data format are the low-capacity wireless communication and the level 4 data format when there is a need to maintain a link connection, when the wireless band interference persists, when the movement of the device is possible, and when the transfer packet size is less than the reference size.

The data format module 144 generates a test packet in the finally selected data format and then transmits or receives the test packet, when the data format is selected finally. The data format module 144 generates a data packet depending on the finally selected data format and then transmits or receives the data packet when the transmission and reception of the test packet is successful. The data format module 144 performs data transmission or reception until the set timeout expires or until an event occurs.

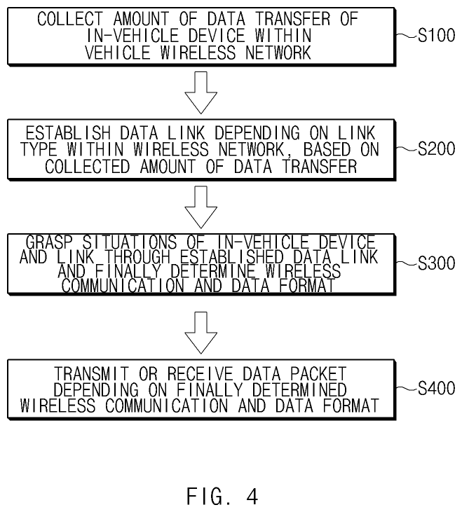

FIG. 4 is a flowchart illustrating a data communication method of an in-vehicle device, in some forms of the present disclosure. For better understanding, some forms of the present disclosure will be described with reference to the wireless network configuration in the vehicle illustrated in FIG. 1.

Referring to FIG. 4, in 5100, the processor 140 of the in-vehicle device 100 collects the amount of data transfer of the in-vehicle devices 100 within a wireless network formed inside a vehicle.

In S200, the processor 140 establishes a data link depending on the link type within the wireless network, based on the collected amount of data transfer of the in-vehicle devices 100. Herein, the link type is classified into a single link (the wireless network is composed of a single link) and multiple links (the wireless network is composed of two or more links).

In S300, the processor 140 determines the wireless communication and the final data format in consideration of the situations of at least one link and in-vehicle devices connected to the link within a wireless network through the established data link.

In S400, the processor 140 transmits or receives a data packet depending on the determined wireless communication and the determined final data format. The processor 140 transmits or receives the data packet until the preset data format hold time elapses or until an event occurs.

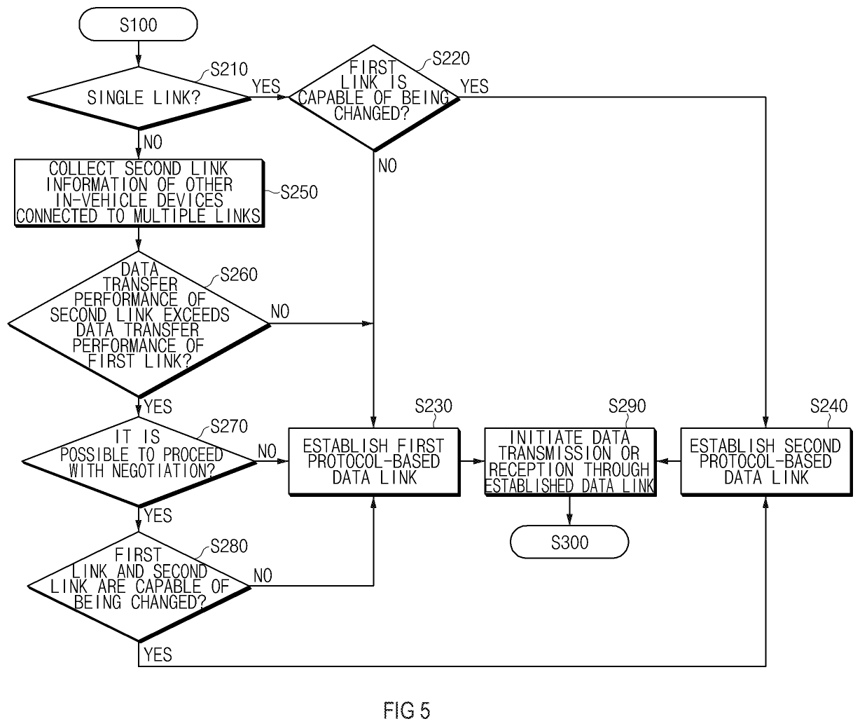

FIG. 5 is a flowchart illustrating a procedure of establishing data link illustrated in FIG. 4. In some forms of the present disclosure, a first link means the link connected to the in-vehicle device 100; a second link means a link other than the first link among links within a wireless network.

Referring to FIG. 5, in S210, the processor 140 of the in-vehicle device 100 determines whether the link within the wireless network is a single link. In other words, the processor 140 of the in-vehicle device 100 determines whether the wireless network is composed of a single link or whether the wireless network is composed of multiple links.

In S220, the processor 140 determines whether the first link connected to the in-vehicle device 100 is capable of being changed, when the wireless network is composed of a single link. The processor 140 determines whether the link between the in-vehicle device 100 and another in-vehicle device is capable of being changed by an external environment and a device situation.

In S230, the processor 140 establishes a first protocol-based data link when the first link is not capable of being changed. In the meantime, in S240, the processor 140 establishes a second protocol-based data link when the first link is capable of being changed.

In S250, the processor 140 collects information about the second link of other in-vehicle devices connected to the multiple links, when the link within the wireless network corresponds to multiple links in S210. The second link information may include the bandwidth, data rate, or the like of the second link.

In S260, the processor 140 determines whether the data transfer performance (capability) of the second link exceeds the data transfer performance of the first link connected to the in-vehicle device 100, based on the second link information. Herein, the data transfer performance of the first link includes the available bandwidth, data rate, and the like, when the first link is single.

In S270, the processor 140 determines whether it is possible to proceed with the negotiation between the in-vehicle device 100 and another in-vehicle device, when the data transfer performance of the second link exceeds the data transfer performance of the first link. Herein, the fact that the negotiation is possible means transmitting or receiving data after the data rate is reduced or transmitting and receiving data through another communication scheme when the lacked portion is present. For example, because the data rate of the second link exceeds the data rate of the first link when the first link between the first device and the second device transmits or receives data at 50 bps and when the second link between the second device and the third device transmits or receives data at 100 bps, the processor 140 of the first device determines whether the data rate of the first link and the second link is capable of being negotiated between devices is possible. That is, the processor 140 determines that the negotiation is possible, when the processor 140 adjusts the data rate of each of the first link and the second link to 50 bps or when the processor 140 transmits or receives the remaining data between the first device and the second device at 50 bps by using another communication scheme different from the communication scheme of the first link while the data is transmitted or received through the first link at 50 bps.

In S280, the processor 140 determines whether the first link and the second link are capable of being changed, when it is possible to proceed with the negotiation. In S230, the processor 140 establishes the first protocol-based data link when the first link and the second link are not capable of being changed. In the meantime, in S240, the processor 140 establishes the second protocol-based data link when the first link and the second link are capable of being changed.

In S230, the processor 140 establishes the first protocol-based data link, when the data transfer performance of the second link does not exceed the data transfer performance of the first link in S260 or when it is impossible to proceed with negotiation in S270.

In S290, the processor 140 initiates data transmission or reception through the established data link, when the first protocol-based data link or the second protocol-based data link is established.

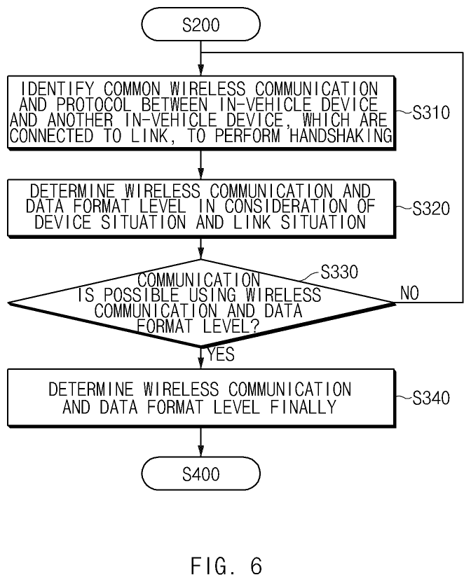

FIG. 6 is a flowchart illustrating a procedure of determining wireless communication and a final data format illustrated in FIG. 4.

The processor 140 of the in-vehicle device 100 establishes a data link with another in-vehicle device, depending on the procedure illustrated in FIG. 5. In other words, the in-vehicle device 100 and the other in-vehicle device, which are connected to the first link, establish the first protocol-based data link or the second protocol-based data link.

In S310, the processor 140 of the in-vehicle device 100 identifies wireless communication and a protocol, which are capable of being used in common with the other in-vehicle device connected through the established data link, to perform initial handshaking. For example, in FIG. 1, the processor 140 of the first in-vehicle device 100a searches for the second in-vehicle device 100b, the third in-vehicle device 100c, and the fourth in-vehicle device 100d through peripheral scanning and then establishes a data link with each of the found devices 100b, 100c, and 100d. The processor 140 of the first in-vehicle device 100a identifies the wireless communication and the protocol (data format), which are capable of being used in common between the devices 100b, 100c, and 100d, through the established data link and performs handshaking for data transmission or reception, using the identified common wireless communication and protocol.

In S320, the processor 140 identifies the device situation and the link situation within the wireless network, using the common wireless communication and protocol and determines the wireless communication and the data format level in consideration of the identified device situation and link situation. The processor 140 determines the wireless communication and the data format level in consideration of whether there is a need to maintain a link connection, whether wireless band interference persists, the possibility of movement (mobility) of a device, a transfer packet size, and the like.

In S330, the processor 140 determines whether the communication is possible, using the determined wireless communication and the determined data format level. The processor 140 generates a test packet depending on the determined data format level and then transmits or receives the test packet, using the determined wireless communication. The processor 140 determines that the communication using the determined wireless communication and the determined data format level is possible, when the transmission or reception of the test packet is successful. In the meantime, the processor 140 determines that the communication using the determined wireless communication and the determined data format level is impossible, when the transmission or reception of the test packet fails. The processor 140 returns to S310 and then performs a procedure of determining the wireless communication and the data format level again, when it is determined that the communication is impossible.

In S340, the processor 140 determines the determined wireless communication and the determined data format level as the final wireless communication and the final data format, when it is determined that the communication is possible.

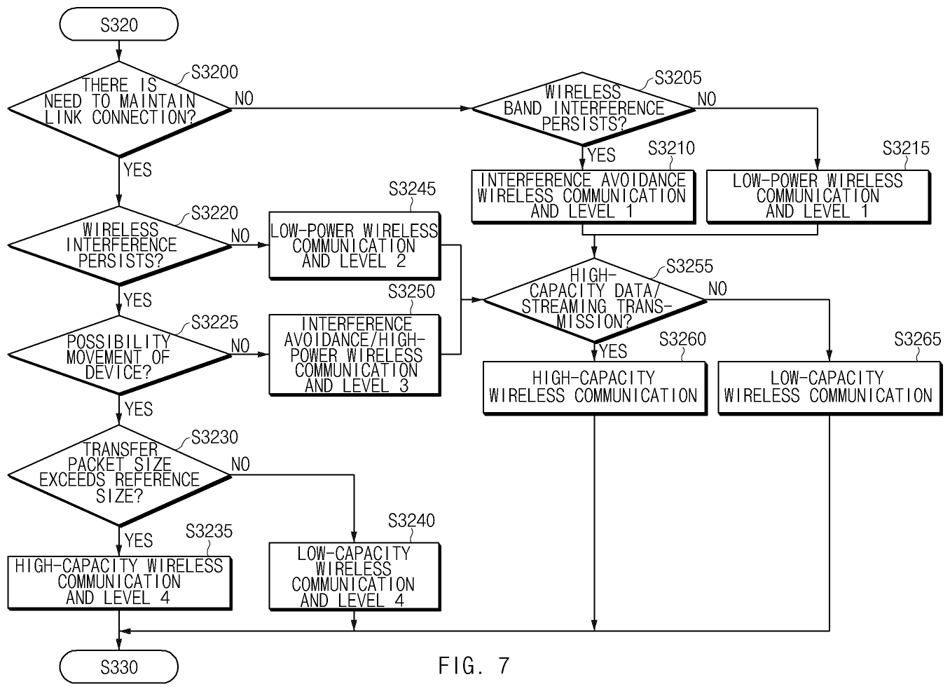

FIG. 7 is a flowchart illustrating a procedure of determining wireless communication and a data format level illustrated in FIG. 6.

Referring to FIG. 7, in S3200, the processor 140 determines whether there is a need to maintain a link connection. In S3205, the processor 140 determines whether wireless band interference persists, when there is no need to maintain the link connection. In S3210, the processor 140 sets the wireless communication in which interference avoidance is possible, to the final wireless communication and sets the data format level to ‘level 1’, when the wireless band interference persists. Meanwhile, in S3215, the processor 140 determines the final wireless communication as low-power wireless communication and sets the data format level to ‘level 1’, when the wireless band interference does not persist.

In S3220, the processor 140 determines whether the wireless band interference persists, when there is a need to maintain the link connection in S3200. In S3225, the processor 140 determines whether the possibility of movement of the in-vehicle device 100 is present, when the wireless band interference persists. In S3230, the processor 140 determines whether the transfer packet size exceeds the reference size pre-stored in the memory 130, when the possibility of movement of the in-vehicle device 100 is present. In S3235, the processor 140 sets the final wireless communication and the final data format level to high-capacity wireless communication and ‘level 4’, when the transfer packet size exceeds the reference size. In the meantime, in S3240, the processor 140 sets the final wireless communication and the final data format level to low-capacity wireless communication and ‘level 4’, when the transfer packet size does not exceed the reference size.

In S3245, the processor 140 sets the final wireless communication and the final data format level to low-power wireless communication and ‘level 2’, when the wireless band interference does not persist in S3220.

In S3250, the processor 140 sets the final wireless communication and the final data format level to interference avoidance and high-power wireless communication and ‘level 3’, when the possibility of movement of the in-vehicle device 100 is not present in S3225.

After S3210, S3215, S3245, or S3250, in S3255, in S3250, the processor 140 determines whether the packet to be transmitted is high-capacity data and whether the packet to be transmitted requires streaming transmission. In S3260, the processor 140 determines the high-capacity wireless communication as the final wireless communication, when the packet to be transmitted is high-capacity data or requires streaming transmission or when the packet to be transmitted is high-capacity data and requires streaming transmission. In the meantime, in S3265, the processor 140 determines the low-capacity wireless communication as the final wireless communication, when the packet to be transmitted is not high-capacity data and does not require streaming transmission.

Hereinafter, the data transmission or reception method in some forms of the present disclosure will be described.

First, a first device and a second device identify the communication schemes (i.e. wireless communication) BT and MQTT, which are capable of being used in common between each other through initial handshaking, and perform connection settings (link establishment) for the communication, when the first device and the second device mounted in a vehicle are connected to each other through one link, when the first device may utilize Wi-Fi, BT, ZigBee, and MQTT, and when the second device may utilize BT, ZigBee, and MQTT.

The first device grasps the surrounding situation of the first device, the surrounding situation of the second device, and a link situation, using packet transmission or reception using BT and MQTT and the transceiver 110. For example, the wireless communication is set to ZigBee and MQTT and the data format level is set to level 1, when the first device is in the condition that only a driver boards a vehicle, when there is no jamming, i.e., wireless band interference, and when only the low-power wireless communication and the low-capacity data are capable of being transmitted. The level 1 data format is the same as the data format in the first protocol.

The first device and the second device perform handshaking, using the first protocol, that is, the level 1 data format. The first device suggests ZigBee and MQTT settings to the second device, using the level 1 data format. The second device transmits a consent response to the first device, when the wireless communication and the data format, which are suggested by the first device, are within an available range and when the surrounding situation is stable. The first device and the second device set the wireless communication and the data format to the wireless communication and the data format, which are negotiated between each other, and transmit or receive the data packet. The first device and the second device identify the common protocol and perform initial handshaking again, when an event for providing a notification that the preset data format hold time elapses occurs.

Next, an IoT 1 establishes a link through scan and handshaking, when the IoT 1 may use Wi-Fi (a/b/g), ZigBee, and HTTP and when an IoT 2 may use Wi-Fi (a/b/g/ac), BT, and HTTP. The IoT 1 identifies the wireless communication of Wi-Fi and HTTP, which are capable of being used in common with the IoT 2, through the established link and performs initial transmission or reception of data through the identified common wireless communication.

The IoT 1 may identify a link connection relationship within a network via the communication with other devices within a network through Wi-Fi and HTTP. It is assumed that the link connection relationship is illustrated in Table 1.

TABLE 1

| | IoT 1 | IoT 2 | IoT 3 | IoT 4 |
|---|---|---|---|---|
| IoT 1 | — | ∘ | x | x |
| IoT 2 | ∘ | — | ∘ | x |
| IoT 3 | x | ∘ | — | ∘ |
| IoT 4 | x | x | ∘ | — |

The IoT 1 may grasp the situation of an IoT 4 through data transmission or reception with the IoT 2. The result of grasping the situation of the IoT 4 indicates that the IoT 1 mounted in a bonnet and the IoT 4 mounted in a trunk need to maintain a connection to synchronize an air cleaning state with each other; the wireless band of the IoT 4 is unstable because the IoT 4 is mounted in a trunk; and interference occurs frequently because the IoT 2, which is mounted on a tire wheel and which operates as an intermediate, and an IoT 3 that is a brake sensor are moved severely. Accordingly, there is a need for the stable amount of transfer. In this case, the link between the IoT 1 and the IoT 2 determines the settings of the level 4 data format, the wireless communication of Wi-Fi (802.11b) and HTTP, and shortened timeout. Next, the IoT 1 and the IoT 2 perform handshaking in the level 4 data format. The IoT 1 suggests the settings of HTTP, Wi-Fi, and shortened timeout to the IoT 2 through the level 4 data format. In the case of the currently available communication scheme and protocol after the IoT 2 identifies the suggestion of the IoT 1, the IoT 2 transmits a consent response.

The negotiation between the IoT 1 and the IoT 2 is applied to the link between the IoT 2 and the IoT 3 and the link between the IoT 3 and the IoT 4. That is, the link between the IoT 2 and the IoT 3 needs to maintain the connection for the communication between the IoT 1 and the IoT 4; the IoT 2 and the IoT 3 need to secure the stable amount of transfer because the IoT 2 and the IoT 3 are moved severely. Accordingly, the IoT 2 and the IoT 3 determine the level 4 data format, Wi-Fi (802.11b), HTTP, and shortened timeout between each other. Furthermore, the link between the IoT 3 and the IoT 4 needs to maintain the connection for the communication between the IoT 1 and the IoT 4; the interference frequently occurs between the IoT 3 and the IoT 4; the IoT 4 is fixed, and thus there is no movement. Accordingly, the IoT 3 and the IoT 4 determine the level 3 data format, Wi-Fi (802.11g), and HTTP.

Afterward, the IoT 1 to the IoT 4 perform transmission or reception of the data packet, using the wireless communication and the protocol (i.e., data format), which are negotiated between each other. The procedure of determining the wireless communication and the protocol may be performed again in only the corresponding section and other data transmission or reception is performed, when an event occurs in one section of the IoT 1 and the IoT 2, the IoT 2 and the IoT 3, and the IoT 3 and the IoT 4.

Hereinabove, although the present disclosure has been described in some forms of the present disclosure and the accompanying drawings, the present disclosure is not limited thereto, but may be variously modified and altered by those skilled in the art to which the present disclosure pertains without departing from the spirit and scope of the present disclosure claimed in the following claims. Therefore, some forms of the present disclosure are provided to explain the spirit and scope of the present disclosure, but not to limit them, so that the spirit and scope of the present disclosure is not limited by some forms of the present disclosure. The scope of the present disclosure should be construed on the basis of the accompanying claims, and all the technical ideas within the scope equivalent to the claims should be included in the scope of the present disclosure.

In some forms of the present disclosure, it may be possible to use the unified data format between links without the update for each device due to the automation of data format settings within a network composed of a plurality of devices.

Furthermore, in some forms of the present disclosure, because situation information of a device and a link with a network is collected again after an event and a specific time and then the wireless communication and the protocol are revised based on the collected situation information, it may be possible to resolve the out-of-date issue of a data format.

Furthermore, in some forms of the present disclosure, it may be possible to flexibly cope with the revision of the data format even though the data format is frequently revised due to the change in the IoT environment of a vehicle.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An in-vehicle device, the device comprising:
a transceiver configured to transmit or receive a packet; and
a processor configured to control an operation of the transceiver,
wherein the processor is configured to:
collect an amount of data transfer of a plurality of in-vehicle devices within a vehicle wireless network;
establish a data link depending on a link type within the wireless network based on the amount of data transfer of the plurality of in-vehicle devices;
determine a wireless communication and a data format based on an in-vehicle device situation and a link situation through the established data link; and
transmit or receive a data packet depending on the determined wireless communication and the determined data format.

2. The device of claim 1, wherein the processor is configured to:
establish a first protocol-based data link or a second protocol-based data link depending on a possibility of a change of a first link when the wireless network is a single link, wherein an in-vehicle device of the plurality of in-vehicle devices is connected with another in-vehicle device of the plurality of in-vehicles devices in the first link.

3. The device of claim 2, wherein the processor is configured to:
determine data transfer performance of a second link connected to the another in-vehicle device of the plurality of in-vehicle devices;
compare the data transfer performance of the second link with data transfer performance of the first link;
analyzes a comparison result; and
establish a first protocol-based data link or a second protocol-based data link depending on the analyzed comparison result when the wireless network is multiple links.

4. The device of claim 3, wherein the processor is configured to:
collect information regarding the in-vehicle device situation and a link through the established data link; and
determine a data format level based on the collected information.

5. The device of claim 4, wherein the processor is configured to:
determine the data format level based on at least one of a need to maintain a link connection, a wireless band interference, a possibility of movement of the in-vehicle device, or a transfer packet size.

6. The device of claim 4, wherein the processor is configured to:
determine the wireless communication based on at least one of a need to maintain a link connection, a wireless band interference, a possibility of movement of the in-vehicle device, a transfer packet size, high-capacity data, or streaming transmission.

7. The device of claim 1, wherein the data format comprises a field for header information, a field for a transaction ID, a field for protocol setting determined among the in-vehicle devices, and a field for a flag, a field for data insertion, and a field for an error check code.

8. The device of claim 7, wherein the data format further comprises a field for maintaining the link connection, and a field for multicast.

9. The device of claim 8, wherein the data format further comprises a field in which a wireless communication standard is included, and a field in which reception signal strength is stored.

10. The device of claim 9, wherein the data format further comprises a field for storing the movement of the in-vehicle device, and a field for storing a time required to maintain the data format.

11. A data communication method, the method comprising:
collecting an amount of data transfer of a plurality of in-vehicle devices within a vehicle wireless network;
establishing a data link based on the amount of data transfer of the plurality of in-vehicle devices depending on a link type within the wireless network;
determining a wireless communication and a data format based on an in-vehicle device situation and a link situation through the data link; and
transmitting and receiving a data packet depending on the wireless communication and the data format.

12. The method of claim 11, wherein establishing the data link comprises:
when the link type corresponds to a single link, establishing a first protocol-based data link or a second protocol-based data link depending on possibility of a change of a first link , wherein an in-vehicle device of the plurality of in-vehicle devices is connected with another in-vehicle device of the plurality of in-vehicle devices in the first link.

13. The method of claim 12, wherein establishing the data link comprises:
when the link type corresponds to multiple links, collecting information of a second link of the another in-vehicle device of the plurality of in-vehicle devices;
determining whether data transfer performance of the second link exceeds data transfer performance of the first link based on information of the second link;
when the data transfer performance of the second link is determined to exceed the data transfer performance of the first link, determining whether to negotiate between the in-vehicle device of the plurality of in-vehicle devices and the another in-vehicle device of the plurality of in-vehicle devices; and
when the in-vehicle device of the plurality of in-vehicle devices and the another in-vehicle device of the plurality of in-vehicle devices are determined to negotiate, establishing the first protocol-based data link or the second protocol-based data link depending on possibility of changes of the first link and the second link.

14. The method of claim 13, wherein determining the wireless communication and the data format comprises:
identifying the wireless communication and a protocol, which are capable of being used in common between the in-vehicle device of the plurality of in-vehicle devices and the another in-vehicle device of the plurality of in-vehicle devices, to perform a handshaking;
collecting information about the in-vehicle device situation and the link situation by using the wireless communication and the protocol to determine a wireless communication standard and a data format level based on the collected information;
determining whether communication is possible through transmission and reception of a test packet at the wireless communication standard and the data format level; and
when the communication is determined to be possible, determining the wireless communication standard and the data format level as the wireless communication and the data format.

15. The method of claim 14, wherein determining the wireless communication standard and the data format level comprises:
determining the data format level based on at least one of a need to maintain a link connection, wireless band interference, possibility of movement of the in-vehicle device, or a transfer packet size.
